(19) United States
(12) Patent Application Publication
(10) Pub. No.: US 2026/0270766 A1
(43) Pub. Date: Sep. 10, 2026

(54) LOW LATENCY INDICATION OPERATION AND SIGNALING

(71) Applicant: APPLE INC., Cupertino, CA (US)

(72) Inventors: Mohamed Abouelseoud, Burlingame, CA (US); Ahmad Reza Hedayat, Carlsbad, CA (US)

(21) Appl. No.: 19/434,953

(22) Filed: Dec. 29, 2025

Related U.S. Application Data
(60) Provisional application No. 63/766,897, filed on Mar. 4, 2025.

(51) Int. Cl. H04W 28/02; H04L 1/1607; H04W 84/12

(52) U.S. Cl. CPC H04W 28/0268; H04L 1/1621; H04W 84/12

(57) ABSTRACT

Embodiments herein describe methods, systems, and apparatuses for low latency indication operation and signaling. A non-Access Point station (non-AP STA) may generate a Stream Classification Service (SCS) request frame including a request to enable use of a low latency indication, send the SCS request frame to an Access Point (AP), and receive a SCS response from the AP. An Access Point station (AP STA) may receive an SCS request frame from a STA including a request to enable use of a low latency indication, and send an SCS response to the STA.

### TECHNICAL FIELD

This application relates generally to wireless communication systems, including the handling of low latency data and indications for buffered low latency data.

### BACKGROUND

Wireless communication technology uses various standards and protocols to transmit data between an access point and a wireless communication device. Wireless communication system standards and protocols can include, for example, 3rd Generation Partnership Project (3GPP) Long Term Evolution (LTE) (e.g., 4G), 3GPP New Radio (NR) (e.g., 5G), and Institute of Electrical and Electronics Engineers (IEEE) 802.11 standard for Wireless Local Area Networks (WLAN) (commonly known to industry groups as Wi-Fi^{®}).

In the 802.11 standard for WLAN, an access point (AP) is a device that creates a wireless local area network (WLAN), or Wi-Fi^{®} network. It may be connected to a wired network, such as an Ethernet network, and provides wireless access to that network for other devices. A station is a device that is capable of being wirelessly connected to the AP to join the WLAN network. Stations can be laptops, smartphones, tablets, or any other device with a WLAN adapter.

APs and stations communicate with each other using the Wi-Fi^{®} protocol. Various protocols have been established to increase security over a wireless communication network. For example, Simultaneous Authentication of Equals is the core authentication protocol of WPA3-Personal, and is mandated to be supported by all Wi-Fi^{®} Alliance certified devices, including both access points (APs) and non-AP stations (STAs).

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 illustrates an example of an AP scheduling uplink traffic after low latency indication from STA during a TXOP, in accordance with some embodiments.

FIG. 2 illustrates an example of an AP scheduling uplink traffic after low latency indication from STA in a future TXOP, in accordance with some embodiments.

FIG. 3 illustrates an example of a STA terminating its TXOP after receiving a low latency termination request, in accordance with some embodiments.

FIG. 4 illustrates an example of an AP scheduling uplink traffic after a low latency indication is received from STA in Initial Control Response, in accordance with some embodiments.

FIG. 5A illustrates an example multi-STA BA that may be used to report low latency information, in accordance with some embodiments.

FIG. 5B illustrates a Per Association Identifier Traffic Identifier Information field that may be included in the BA Information field, in accordance with some embodiments.

FIG. 5C illustrates an example format of a Per AID TID Info subfield in accordance with some embodiments.

FIG. 6A illustrates an example SCS Request frame Action field, in accordance with some embodiments.

FIG. 6B illustrates an example QoS Characteristic Element in accordance with some embodiments.

FIG. 6C illustrates an example control information field in accordance with some embodiments.

FIG. 7 illustrates an example system for performing signaling between a wireless device and a network device, according to embodiments disclosed herein.

FIG. 8 is a flowchart illustrating a method for a non-Access Point station (non-AP STA), in accordance with some embodiments.

FIG. 9 is a flowchart illustrating a method for an Access Point station (AP STA), in accordance with some embodiments.

FIG. 10 is a flowchart illustrating a method for a transmission opportunity (TXOP) responder, in accordance with some embodiments.

FIG. 11 is a flowchart illustrating a method for a TXOP holder, in accordance with some embodiments.

### DETAILED DESCRIPTION

Wireless communication technology uses various standards and protocols to transmit data between an access point and a wireless communication device. One standard that is used for wireless communication is the Institute of Electrical and Electronics Engineers (IEEE) 802.11 standard for Wireless Local Area Networks (WLAN) (commonly known to industry groups as Wi-Fi^{®}). Wi-Fi^{®} provides a convenient way to establish a network between devices. A device (e.g., a station) may connect to a Wi-Fi^{®} access point to join a network and connect to the internet wirelessly.

An Access Point (AP) is a device that creates a wireless local area network (WLAN), or Wi-Fi^{®} network. A station (STA) is a device that is capable of being wirelessly connected to the AP to join the network. A mobile-AP is a device that can function as a portable AP to provide internet access to nearby STAs. For example, a mobile-AP may be a cellular phone with hotspot mode enabled.

Various embodiments are described with regard to a (STA) and Access Point (AP). However, reference to a STA and AP is merely provided for illustrative purposes. The example embodiments may be utilized with any electronic component that may establish a connection to a network and is configured with the hardware, software, and/or firmware to exchange information and data with the network. Therefore, the STAs and APs as described herein are used to represent any appropriate electronic component.

One of the goals in a Wi-Fi^{®} communication system is reducing latency for latency sensitive data. Some networks may employ preemption for minimal delays for low latency data. Preemption refers to the ability of a device to interrupt ongoing transmissions in order to prioritize more urgent or time-sensitive data. This mechanism may ensure that high-priority traffic can be transmitted with minimal delay, even if the network is congested.

In some embodiments, preemption may be limited to responder requests. The transmission opportunity (TXOP) initiator may limit PPDU duration in TXOP to a target length. The TXOP responder can request to take over the TXOP for low latency data transmission. The TXOP responder can request to disengage from current TXOP.

Some embodiments may define or improve existing mechanisms so that a non-AP STA that is a TXOP responder can indicate its buffered low latency traffic needs (for traffic from the TXOP responder to the TXOP Holder) in a control response frame. The TXOP holder may consider the indication in determining subsequent actions. Note that whether an AP can indicate its low latency needs may also be considered.

In some embodiments the STA may send a low latency indication in a control response frame (e.g., an Acknowledgment (ACK) or a Multi-STA (M-STA) Block ACK) for preemption. Embodiments herein discuss further details on enabling and using the low latency indication. Low latency indication is an Ultra High Reliability (UHR) capability for non-AP STAs and APs. STAs may use low latency indication to inform peer STAs of pending low latency traffic or low latency needs. The TXOP holder should use the low latency indication to fulfil TXOP responder needs. Tools are available in the IEEE 802.11 standard to share the TXOP (Uplink Orthogonal Frequency Division Multiple Access (UL OFDMA), Multi-User Request to Send Transmission Status (MU-RTS TXS), Reverse Direction (RD),…) or schedule future TXOP for low latency UL transmission.

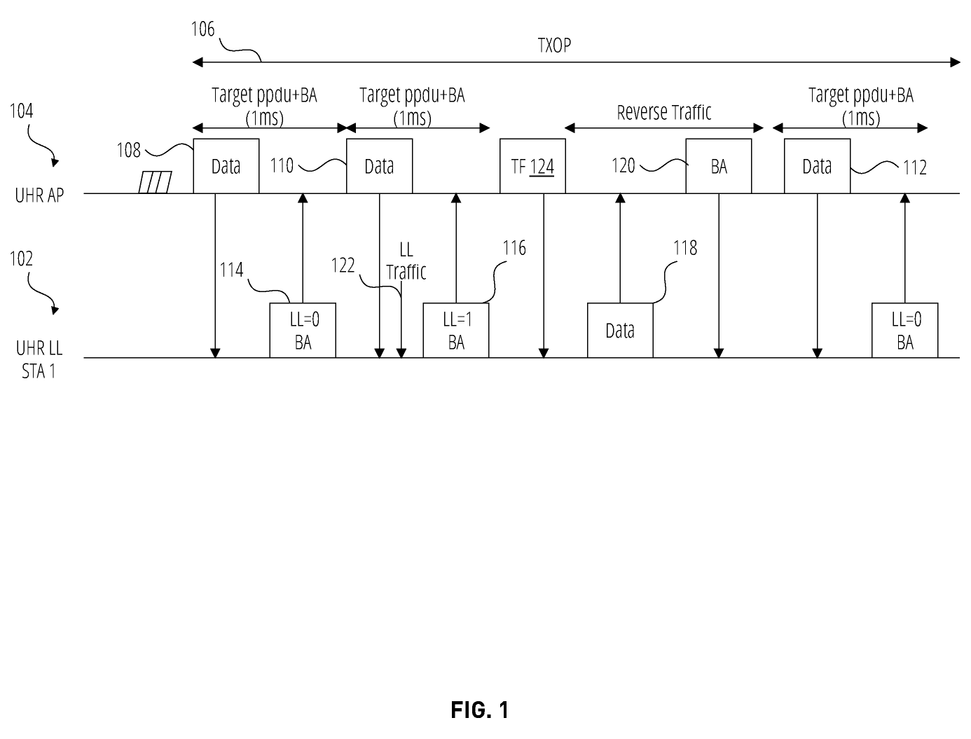

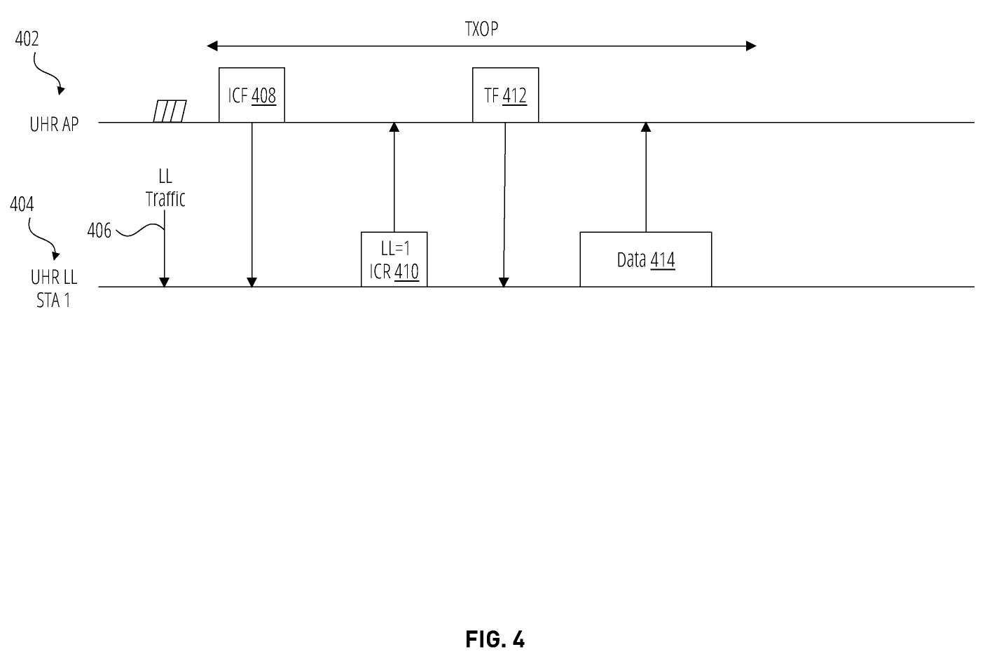

FIG. 1 - FIG. 4 illustrate examples of the use of a low latency indication by a TXOP responder (e.g., STA). The TXOP responder may need to get an opportunity during the TXOP to send a low latency indication. The TXOP initiator (e.g., AP) may limit the Physical Protocol Data Unit (PPDU) length to allow low latency indication transmissions during the TXOP. If TXOP responder reports buffered low latency frames, TXOP initiator can allow reverse traffic (e.g., through reverse direction grant (RDG), trigger frame (TF), and/or MU-RTS TXS).

FIG. 1 illustrates an example of an AP 104 scheduling uplink traffic after low latency indication from STA 102 during a TXOP 106, in accordance with some embodiments. The AP 104 may break the data into smaller data units (e.g., PPDU 108, PPDU 110, and PPDU 112). By limiting the PPDU length, the AP 104 may provide the STA 102 with the opportunity to send a low latency indication more often.

In the illustrated example, the AP 104 sends a PPDU 108. In response, the STA 102 sends a Block ACK (BA 114). The BA 114 indicates that the PPDU 108 was successfully received. The BA 114 may also include an indication of whether the STA 102 has low latency data or not. In the BA 114 the low latency indication is set to zero to indicate that the STA 102 is not buffering low latency data.

As there is no low latency data from the STA 102, the AP 104 may send another PPDU 110. In response, the STA 102 may send another BA 116. However, before the BA 116 is sent, the STA 102 receives or generates low latency traffic 122. Accordingly, the BA 116 includes a low latency indication set to one to indicate that the STA 102 is buffering low latency data.

In response to the BA 116 indicating buffered low latency data, the AP 104 may send a TF 124 to the STA 102 to trigger reverse traffic to be transmitted from the STA 102 to the AP 104. The STA 102 sends the uplink data 118. The AP 104 may response with a BA 120. If there is still time in the TXOP 106, the AP 104 may continue data transmission (e.g., PPDU 112).

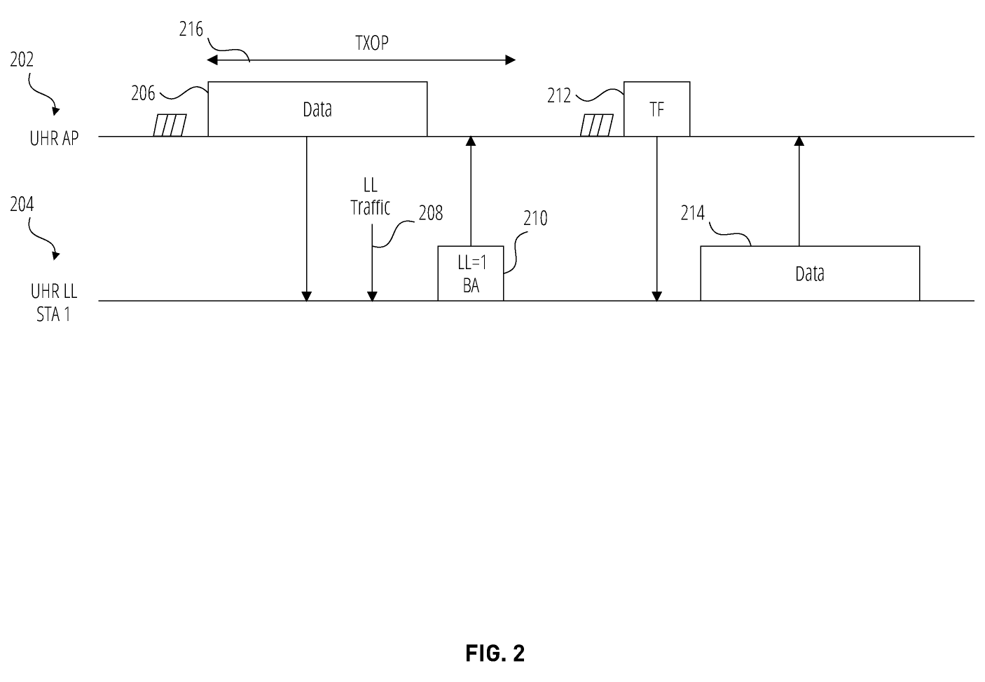

FIG. 2 illustrates an example of an AP 202 scheduling uplink traffic after low latency indication from STA 204 in a future TXOP, in accordance with some embodiments. As shown, the AP 202 may send downlink data 206 during a TXOP 216. The STA 204 may generate or receive low latency traffic 208. In response to receiving the downlink data 206, the STA 204 can send a BA 210. The BA 210 includes a low latency indication. The low latency indication is set to one to indicate the buffered low latency traffic 208.

As the TXOP 216 is ending, the AP 202 may schedule the uplink traffic in a future TXOP. For example, the AP 202 may contend for the channel after the TXOP 216 and then send a TF 212 to the STA 204 to trigger reverse traffic to be transmitted from the STA 204 to the AP 202. The STA 204 sends the uplink data 214.

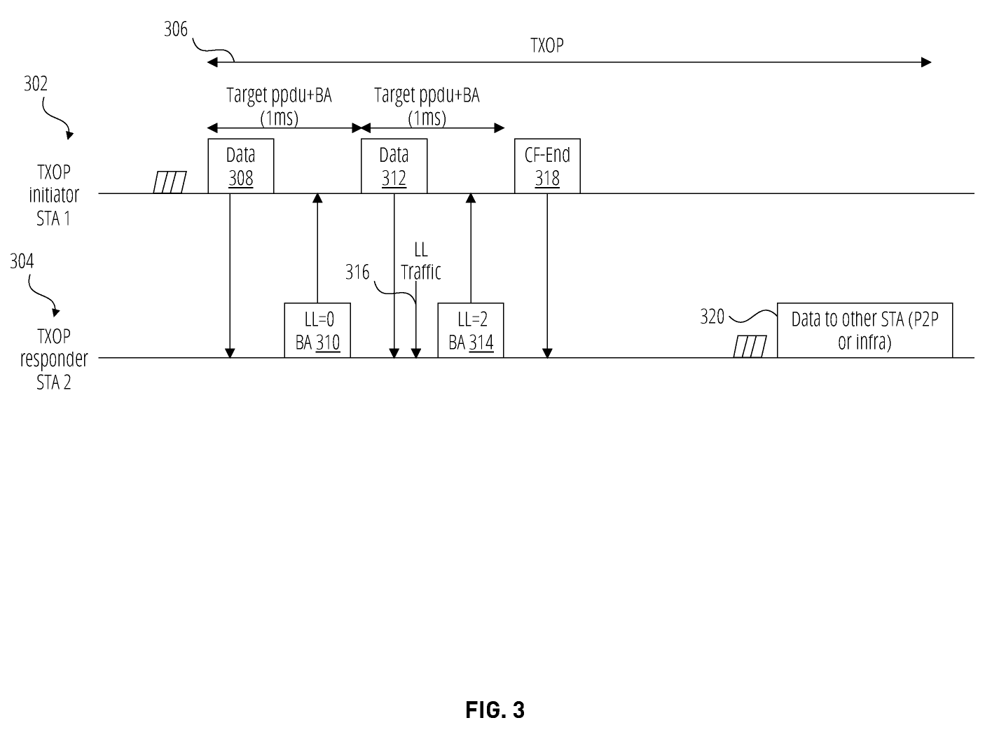

A TXOP responder can request to terminate the TXOP to send traffic on a different link or to another STA. For example, FIG. 3 illustrates an example of an STA (e.g., first STA 302) terminating its TXOP 306 after receiving a low latency termination request, in accordance with some embodiments. As shown, the first STA 302 may initiate a TXOP 306 with a second STA 304. However, if low latency data is received by the second STA 304, the second STA 304 may desire to end the TXOP 306.

In the illustrated example, the first STA 302 may send a PPDU 308. In response, the second STA 304 may send the BA 310. The BA 310 indicates that the PPDU 308 was successfully received. The BA 310 may also include an indication of whether the second STA 304 has low latency data or not. In the BA 310 the low latency indication is set to zero to indicate that the second STA 304 is not buffering low latency data.

As there is no low latency data from the second STA 304, the first STA 302 may send another PPDU 312. In response, the second STA 304 may send another BA 314. However, before the BA 314 is sent, the second STA 304 receives or generates low latency traffic 316. Accordingly, the BA 314 includes a low latency indication set to two to indicate that some action or data to transmit requires that the first STA 302 terminates the TXOP 306. Thus, the BA 314 may serve as a request to terminate the TXOP 306 based on the low latency indication.

In response, the first STA 302 may terminate the TXOP 306 and send a contention-free end frame (CF-End 318) to the second STA 304. The second STA 304 is free to send data to other STAs or AP (e.g., data 320).

The TXOP responder can add the low latency indication in the initial control response, and the TXOP initiator can schedule reverse traffic accordingly. For example, FIG. 4 illustrates an example of an AP 402 scheduling uplink traffic after a low latency indication is received from STA 404 in Initial Control Response (ICR 410), in accordance with some embodiments. As shown, the STA 404 may receive or generate low latency traffic 406. The AP 402 may send an initial control frame (ICF 408).

In response, the STA 404 may send an ICR 410. The ICR 410 may include a low latency indication. In the illustrated embodiment, the low latency indication is set to one to indicate that the STA 404 is buffering low latency traffic 406 for reverse traffic. The AP 402 may send a TF 412 to trigger the STA 404 to send the data 414.

For the examples above, the role of AP and non-AP STAs can be reversed without any loss of generality.

Embodiments herein propose details regarding low latency indication mode operation. In some embodiments, when the low latency indication mode is enabled, a TXOP initiator is expecting to receive low latency indication from a TXOP responder in the control response frames. A TXOP initiator may expect to receive low latency indication in the immediate control response when it transmits any PPDU to the TXOP responder. A TXOP initiator can solicit the low latency indication in the ICR by sending an ICF that allows the feedback to be sent (Basic Service Request Protocol – Multi-Station BA (BSRP-M-STA BA) frame sequence for example).

A STA that has low latency indication mode enabled may use Multi-STA (M-STA) BA as the immediate control response to send the low latency indication and acknowledge received PPDUs. A STA that has low latency indication mode enabled can use M-STA BA as the initial control response when applicable to send low latency indication. The TXOP initiator can account for M-STA BA with low latency indication information when calculating the TXOP duration. In some embodiments, a PPDU target limit may be set. When the PPDU target limit is set, the TXOP initiator should use the suggested target PPDU duration when sending non-low latency traffic to the TXOP responder to enable low latency indication during the TXOP.

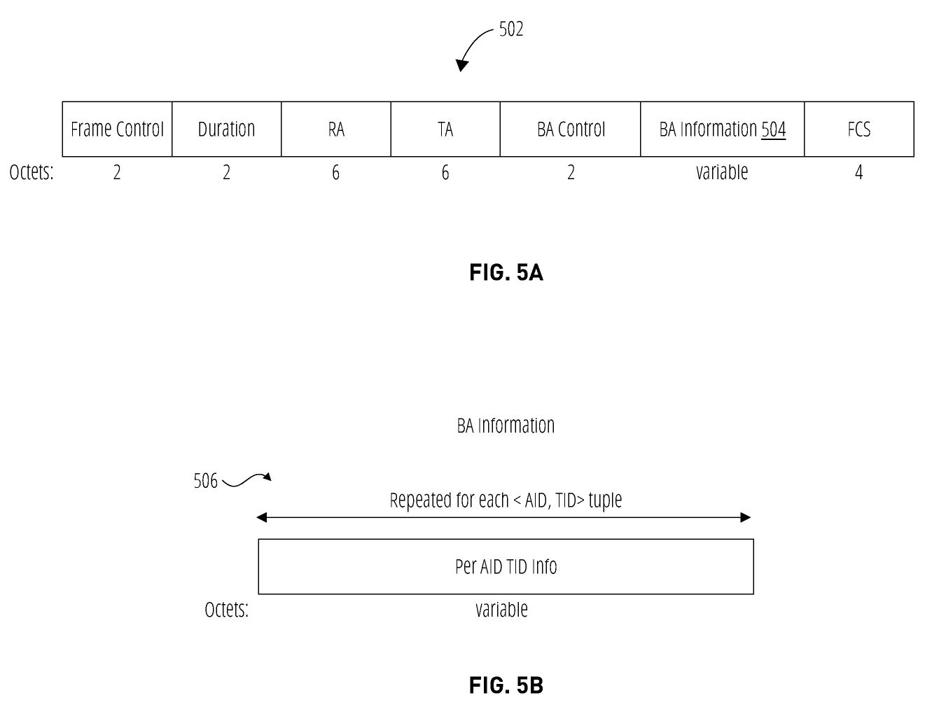

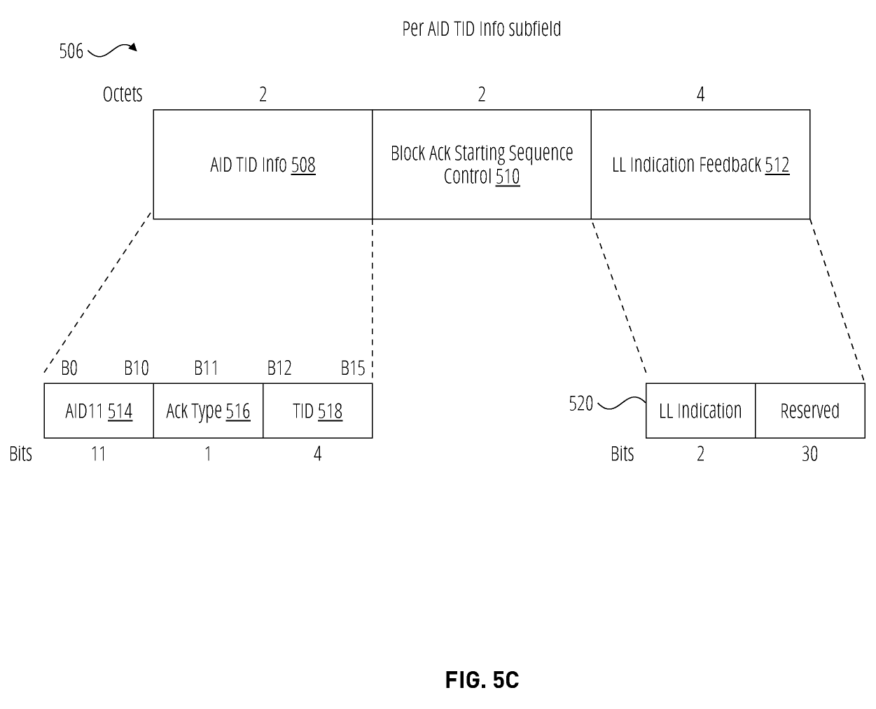

FIG. 5A- FIG. 5C illustrate an example multi-STA BA format for low latency indication reporting. FIG. 5A illustrates an example multi-STA BA 502 that may be used to report low latency information, in accordance with some embodiments. As shown, the multi-STA BA 502 may include a BA Information field 504. The BA Information field 504 may include a low latency indication.

For example, FIG. 5B illustrates a Per Association Identifier Traffic Identifier Information field (e.g., per AID TID Info subfield 506) that may be included in the BA Information field 504 in accordance with some embodiments. The per AID TID Info subfield 506 may be used to carry the low latency indication information.

FIG. 5C illustrates an example format of a Per AID TID Info subfield 506 in accordance with some embodiments. As shown, the Per AID TID Info subfield 506 may include AID TID Info field 508, Block Ack Starting Sequence Control field 510, and Low Latency Indication Feedback field 512.

The AID TID Info field 508 may include an AID11 subfield 514, an Ack Type 516, and a TID subfield 518. The AID TID Info field 508 and the Block Ack Starting Sequence Control field 510 may be used to indicate that the Per AID TID Info subfield 506 includes a low latency indication instead of a BA bitmap. In other words, the low latency indication may be included in a BA bitmap field in place of a BA bitmap. For example, the AID11 subfield 514 may carry the AID of the STA where the feedback is sent to (0 in case of AP). For example, the Ack Type 516 may be set to Ack Type 0 and the TID subfield 518 may be set to value 13 to indicate feedback to the peer STA. The Block Ack Starting Sequence Control field 510 or a subset of this subfield may indicate the type of feedback (low latency indication).

The Low Latency Indication Feedback field 512 and the Block Ack Bitmap includes the low latency indication 520 instead of the BA bitmap. In some embodiments, options for the low latency indication 520 include the following. The value of the Low Latency Indication Feedback field 512 may be used to indicate low latency data, low latency date available, or a request to terminate the TXOP. In some embodiments, when the low latency indication 520 is set to a value zero, no low latency data is indicated. In some embodiments, when the low latency indication 520 is set to a value one, low latency data is available. In some embodiments, when the low latency indication 520 is set to a value two for a request to terminate the TXOP. In some embodiments, a value of three may be reserved. More values may be used to feedback other low latency needs to the TXOP holder.

The AP and non-AP STAs may use an enablement procedure to agree on enabling the low latency indication. The TXOP holder can account for multi-STA BA with low latency indication information when calculating TXOP duration and block ACK resources. The TXOP holder can use the PPDU target limit according to the TXOP initiator latency needs.

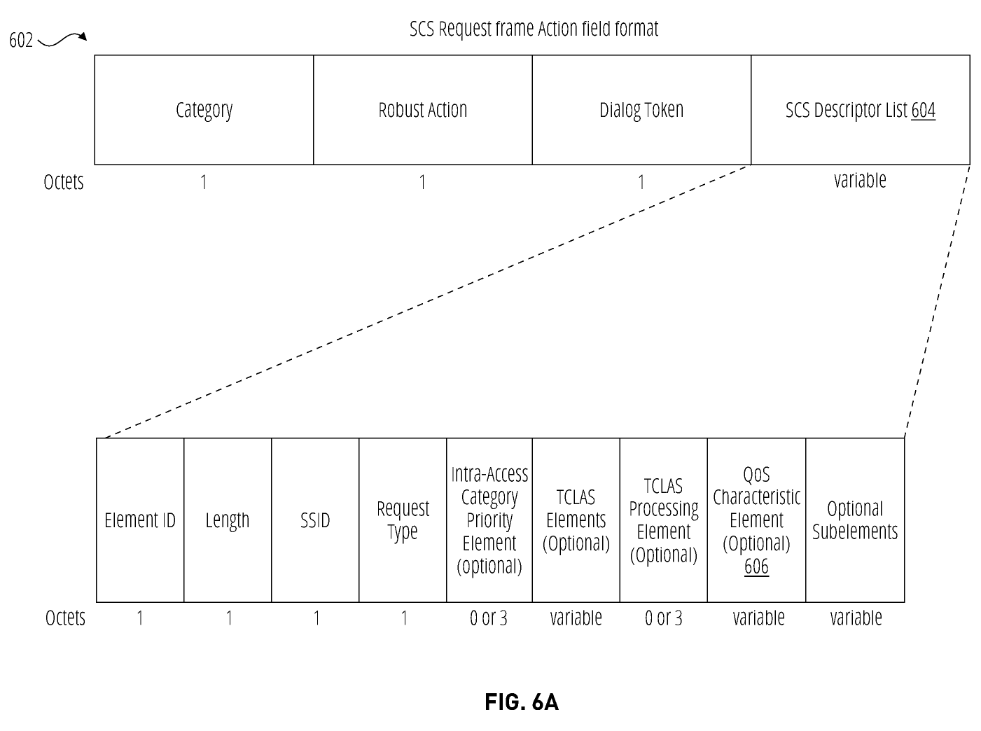

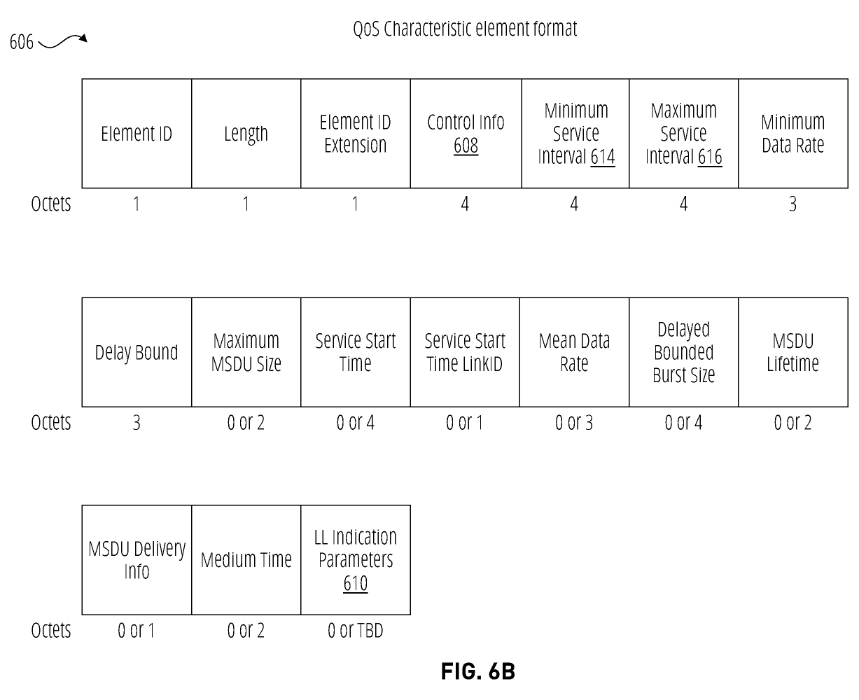

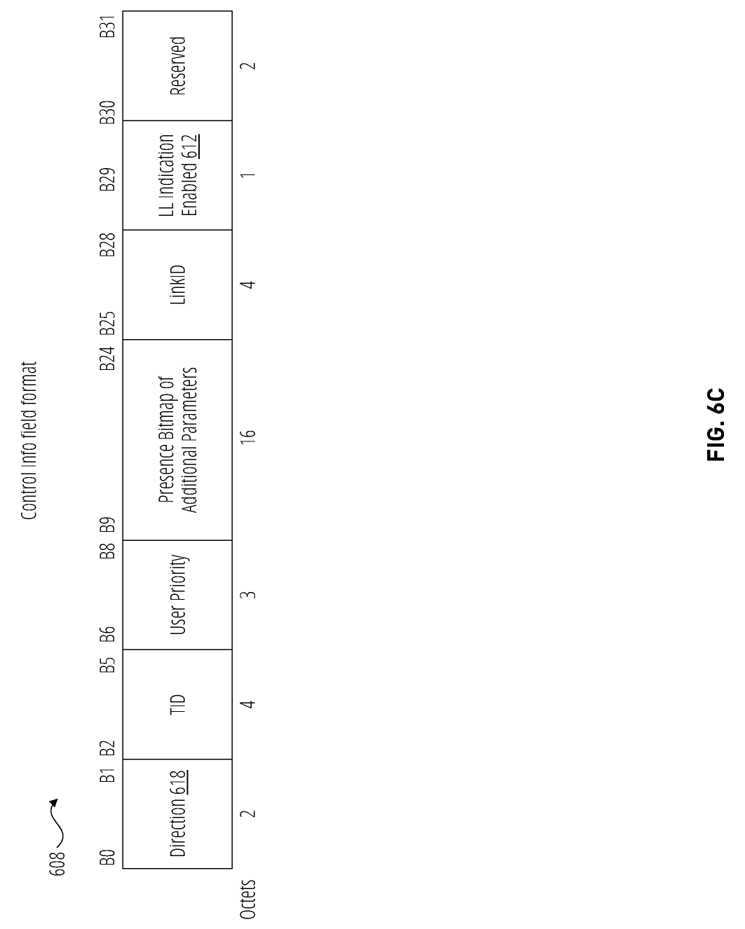

In some embodiments, the Low Latency indication enablement may be done through Stream Classification Service (SCS). For example, a non-AP STA with low latency capability enabled can use an SCS procedure to enable low latency indication. The SCS Request and SCS response frames may be exchanged to request to enable low latency indication and set the parameters. Low Latency indication enablement and parameters can be added to the quality of service (QoS) Characteristic element. FIG. 6A - FIG. 6C illustrate an example of how SCS can be used for enabling the low latency indication.

FIG. 6A illustrates an example SCS Request frame Action field 602, in accordance with some embodiments. The SCS Request frame Action field 602 may be part of an SCS request frame that is sent by a STA with low latency capability to enable low latency indication. As shown, the SCS Request frame Action field 602 may include an SCS Descriptor List 604. The SCS Descriptor List 604 may include a QoS Characteristic Element 606. The QoS Characteristic Element 606 may include a low latency indication enablement and parameters.

For example, FIG. 6B illustrates an example QoS Characteristic Element 606 in accordance with some embodiments. The QoS Characteristic Element 606 may include a control information field 608. A new bit or subfield may be used in the control information field 608 to indicate low latency enablement request or update.

FIG. 6C illustrates an example control information field 608 in accordance with some embodiments. The control information field 608 includes a Low Latency Indication Enabled subfield 612 that may be used to indicate low latency enablement request or update. For example, in some embodiments Low Latency Indication Enabled subfield 612 may be set to one to indicate a low latency enablement request or update, and zero to indicate that the SCS request is not requesting or updating low latency enablement.

When the Low Latency Indication Enabled subfield 612 is set to one, if the Minimum Service Interval and Maximum Service Interval (e.g., Minimum Service Interval 614 and Maximum Service Interval 616 shown in FIG. 6B) are unspecified/unknown the non-AP STA may set the Direction subfield 618 to zero (uplink (UL)). The Direction subfield 618 specifies the direction of data transmission. Setting the Direction subfield 618 to zero may indicate the uplink. The non-AP STA can also set the Minimum Service Interval and Maximum Service Interval (e.g., Minimum Service Interval 614 and Maximum Service Interval 616 shown in FIG. 6B) to zero (zero is currently a reserved value for the Minimum Service Interval and Maximum Service Interval). Otherwise, non-AP STA sets the Minimum Service Interval and Maximum Service Intervals as usual.

When Minimum Service Interval 614 and Maximum Service Interval 616 are set to zero in uplink direction with enabled low latency indication (e.g., Low Latency Indication Enabled subfield 612 set to one), the AP does not consider this QoS characteristic element as a reference for scheduling and only considers it for enabling low latency indication.

Returning to FIG. 6B, the QoS Characteristic Element 606 may include low latency indication parameters 610. Low latency indication parameters 610 may be optionally added when low latency indication is enabled (e.g., Low Latency Indication Enabled subfield 612 set to one). The Presence Bitmap of Additional Parameter subfield in the Control Info field indicates the presence of the Low Latency Indication Parameter subfield in the QoS Characteristic element by setting the bit in the bitmap that is associated to its order, bit 9 in the bitmap in this example. The low latency indication parameters may include a field for the target PPDU length. The target PPDU length field may allow the TXOP responder to provide the TXOP initiator with a suggested targeted PPDU length for non-low latency (non-LL) traffic. The TXOP initiator should limit the PPDU duration to the target length if possible. In some embodiments, the bit associated to the Low Latency Indication Parameters subfield in the Presence Bitmap of Additional Parameter subfield in the Control Info field can be used to indicate the enablement request/update for low latency indication mode instead of the proposed LL indication Enabled 612 bit in the Control Info field. Low Latency Indication Parameter subfield can also carry the enablement bit request/update in addition to any other parameters.

The following are examples of possible low latency indication and QoS characteristics configurations. In some embodiments, if Low Latency Indication Enabled subfield 612 is set to one, and Minimum Service Interval 614 and Maximum Service Interval 616 are specified for any direction, the AP enables Low Latency Indication mode, and the AP should schedule transmission according to the QoS Characteristic Element 606.

In some embodiments, if Low Latency Indication Enabled subfield 612 is set to one, and Minimum Service Interval 614 and Maximum Service Interval 616 are unspecified (zero) for uplink direction, the AP enables Low Latency indication mode, and the AP does not consider this QoS Characteristic element for future scheduling.

In some embodiments, if Low Latency Indication Enabled subfield 612 is set to 0, the AP uses QoS Characteristic element as usual.

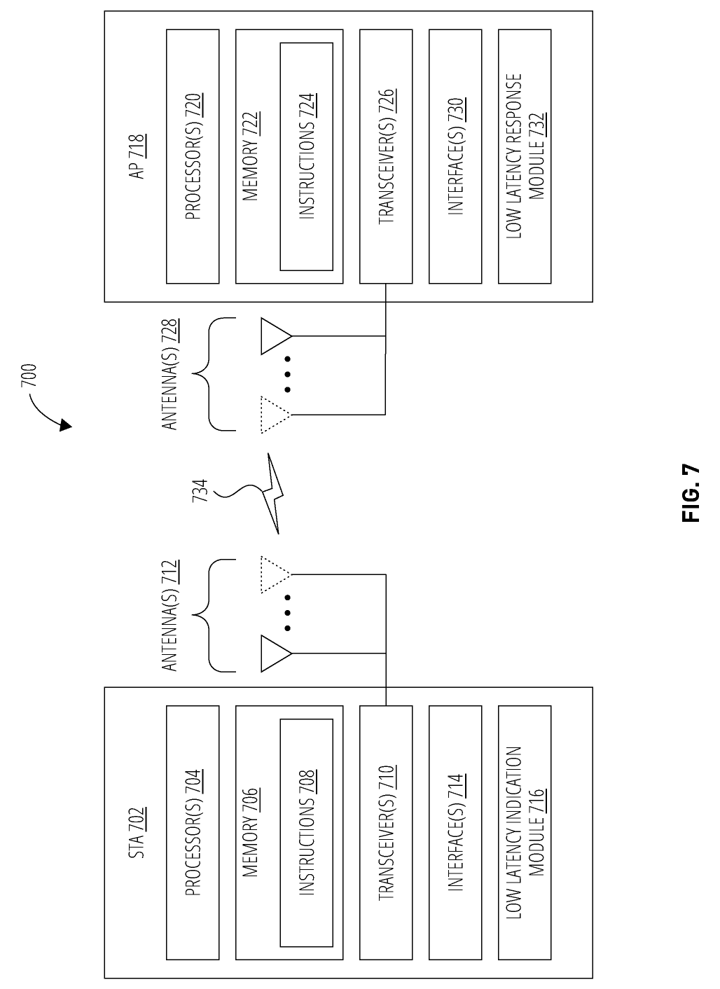

FIG. 7 illustrates a system 700 for performing signaling 734 between an STA 702 and an AP 718, according to embodiments disclosed herein. The system 700 may be a portion of a wireless communications system as herein described. The STA 702 may be, for example, a UE of a wireless communication system, a non-AP STA, or an AP STA. The AP 718 may be, for example, an access point of a wireless communication system. In some embodiments, the AP 718 may be an AP STA.

The STA 702 may include one or more processor(s) 704. The processor(s) 704 may execute instructions such that various operations of the STA 702 are performed, as described herein. The processor(s) 704 may include one or more baseband processors implemented using, for example, a central processing unit (CPU), a digital signal processor (DSP), an application specific integrated circuit (ASIC), a controller, a field programmable gate array (FPGA) device, another hardware device, a firmware device, or any combination thereof configured to perform the operations described herein.

The STA 702 may include a memory 706. The memory 706 may be a non-transitory computer-readable storage medium that stores instructions 708 (which may include, for example, the instructions being executed by the processor(s) 704). The instructions 708 may also be referred to as program code or a computer program. The memory 706 may also store data used by, and results computed by, the processor(s) 704.

The STA 702 may include one or more transceiver(s) 710 that may include radio frequency (RF) transmitter circuitry and/or receiver circuitry that use the antenna(s) 712 of the STA 702 to facilitate signaling (e.g., the signaling 734) to and/or from the STA 702 with other devices (e.g., the AP 718).

The STA 702 may include one or more antenna(s) 712 (e.g., one, two, four, or more). For embodiments with multiple antenna(s) 712, the STA 702 may leverage the spatial diversity of such multiple antenna(s) 712 to send and/or receive multiple different data streams on the same time and frequency resources. This behavior may be referred to as, for example, multiple input multiple output (MIMO) behavior (referring to the multiple antennas used at each of a transmitting device and a receiving device that enable this aspect). MIMO transmissions by the STA 702 may be accomplished according to precoding (or digital beamforming) that is applied at the STA 702 that multiplexes the data streams across the antenna(s) 712 according to known or assumed channel characteristics such that each data stream is received with an appropriate signal strength relative to other streams and at a desired location in the spatial domain (e.g., the location of a receiver associated with that data stream). Certain embodiments may use single user MIMO (SU-MIMO) methods (where the data streams are all directed to a single receiver) and/or multiuser MIMO (MU-MIMO) methods (where individual data streams may be directed to individual (different) receivers in different locations in the spatial domain).

In certain embodiments having multiple antennas, the STA 702 may implement analog beamforming techniques, whereby phases of the signals sent by the antenna(s) 712 are relatively adjusted such that the (joint) transmission of the antenna(s) 712 can be directed (this is sometimes referred to as beam steering).

The STA 702 may include one or more interface(s) 714. The interface(s) 714 may be used to provide input to or output from the STA 702. For example, an STA 702 that is a UE may include interface(s) 714 such as microphones, speakers, a touchscreen, buttons, and the like in order to allow for input and/or output to the UE by a user of the UE. Other interfaces of such a UE may be made up of transmitters, receivers, and other circuitry (e.g., other than the transceiver(s) 710/antenna(s) 712 already described) that allow for communication between the UE and other devices and may operate according to known protocols (e.g., Wi-Fi^{®}, Bluetooth®, and the like).

The STA 702 may include a low latency indication module 716. The low latency indication module 716 may be implemented via hardware, software, or combinations thereof. For example, the low latency indication module 716 may be implemented as a processor, circuit, and/or instructions 708 stored in the memory 706 and executed by the processor(s) 704. In some examples, the low latency indication module 716 may be integrated within the processor(s) 704 and/or the transceiver(s) 710. For example, the low latency indication module 716 may be implemented by a combination of software components (e.g., executed by a DSP or a general processor) and hardware components (e.g., logic gates and circuitry) within the processor(s) 704 or the transceiver(s) 710.

The low latency indication module 716 may be used for various aspects of the present disclosure. The low latency indication module 716 is configured to report low latency information via a BA (e.g., a multi-STA BA) and authenticate the AP 718 and send a request to enable low latency indication reporting via an SCS request frame.

The AP 718 may include one or more processor(s) 720. The processor(s) 720 may execute instructions such that various operations of the AP 718 are performed, as described herein. The processor(s) 720 may include one or more baseband processors implemented using, for example, a CPU, a DSP, an ASIC, a controller, an FPGA device, another hardware device, a firmware device, or any combination thereof configured to perform the operations described herein.

The AP 718 may include a memory 722. The memory 722 may be a non-transitory computer-readable storage medium that stores instructions 724 (which may include, for example, the instructions being executed by the processor(s) 720). The instructions 724 may also be referred to as program code or a computer program. The memory 722 may also store data used by, and results computed by, the processor(s) 720.

The AP 718 may include one or more transceiver(s) 726 that may include RF transmitter circuitry and/or receiver circuitry that use the antenna(s) 728 of the AP 718 to facilitate signaling (e.g., the signaling 734) to and/or from the AP 718 with other devices (e.g., the STA 702).

The AP 718 may include one or more antenna(s) 728 (e.g., one, two, four, or more). In embodiments having multiple antenna(s) 728, the AP 718 may perform MIMO, digital beamforming, analog beamforming, beam steering, etc., as has been described.

The AP 718 may include one or more interface(s) 730. The interface(s) 730 may be used to provide input to or output from the AP 718. For example, an AP 718 that is a base station may include interface(s) 730 made up of transmitters, receivers, and other circuitry (e.g., other than the transceiver(s) 726/antenna(s) 728 already described) that enables the base station to communicate with other equipment in a core network, and/or that enables the base station to communicate with external networks, computers, databases, and the like for purposes of operations, administration, and maintenance of the base station or other equipment operably connected thereto.

The AP 718 may include a Low latency response module 732. The Low latency response module 732 may be implemented via hardware, software, or combinations thereof. For example, the Low latency response module 732 may be implemented as a processor, circuit, and/or instructions 724 stored in the memory 722 and executed by the processor(s) 720. In some examples, the Low latency response module 732 may be integrated within the processor(s) 720 and/or the transceiver(s) 726. For example, the Low latency response module 732 may be implemented by a combination of software components (e.g., executed by a DSP or a general processor) and hardware components (e.g., logic gates and circuitry) within the processor(s) 720 or the transceiver(s) 726.

The Low latency response module 732 may be used for various aspects of the present disclosure. The Low latency response module 732 is configured to respond to low latency indication enablement requests through an SCS response, configure the AP 718 based on the SCS request, and handle a BA with a low latency indication.

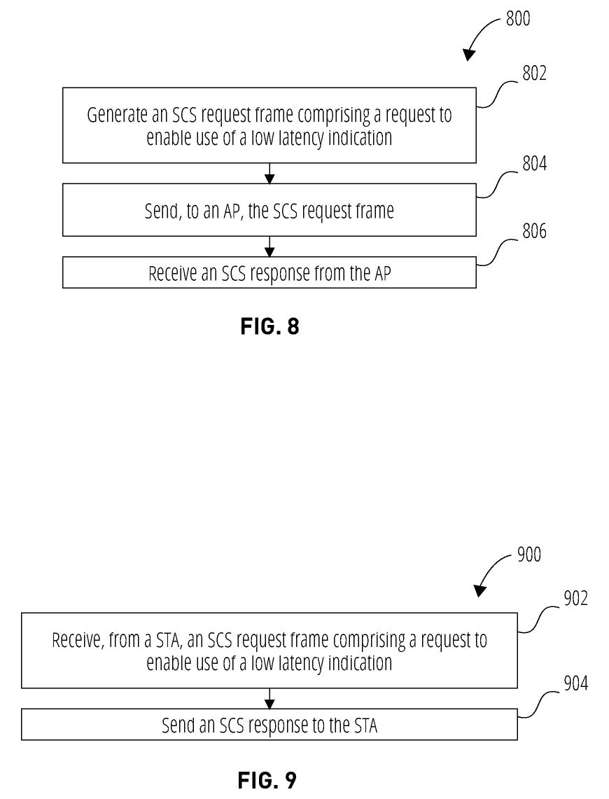

FIG. 8 is a flowchart illustrating a method 800 for a non-Access Point station (non-AP STA). The method 800 includes: generating 802 a Stream Classification Service (SCS) request frame comprising a request to enable use of a low latency indication; sending 804, to an Access Point (AP), the SCS request frame; and receiving 806 an SCS response from the AP.

In certain embodiments of the method 800, the SCS request frame further comprises low latency indication parameters. In certain such embodiments, the low latency indication parameters comprise a suggested targeted Physical Protocol Data Unit (PPDU) length for non-low latency traffic. In addition, or in other embodiments, the request to enable use of the low latency indication and the low latency indication parameters are included in a quality of service (QoS) characteristic element of the SCS request frame. In certain such embodiments, the SCS request frame further comprises a minimum service interval and a maximum service interval, and wherein the method further comprises, when the minimum service interval and the maximum service interval are set to zero in uplink direction with the request to enable use of the low latency indication, indicating to the AP to not consider the QoS characteristic element as a reference for scheduling and only consider the QoS characteristic element for enabling the low latency indication.

In certain embodiments, when the non-AP STA is a transmission opportunity (TXOP) responder, the method 800 further includes generating, in response to pending low latency data or low latency needs, a Multi-Station Block Acknowledgement (M-STA BA) comprising a per Association Identifier Traffic Identifier Information (AID TID info) subfield that includes: a Block Acknowledgement (BA) starting sequence control that indicates that the per AID TID info subfield includes a low latency type of feedback; and the low latency indication for the pending low latency data or the low latency needs. In such embodiments, the method 800 further includes sending the M-STA BA to an associated STA or a TXOP holder to inform the associated STA or the TXOP holder of the pending low latency data or the low latency needs. The low latency indication may be included in the per AID TID info subfield in place of a BA bitmap. In certain embodiments, the method 800 further includes receiving a trigger frame, a Multi-User Request to Send Transmission Status (MU-RTS TXS), or a Reverse Direction Grant (RDG) from the associated STA or the TXOP holder; and sending the pending low latency data or attending to the low latency needs in response to the trigger frame, the MU-RTS TXS, or the RDG.

In certain embodiments, when the non-AP STA is a transmission opportunity (TXOP) holder, the method 800 further includes receiving, from a station (STA), a Multi-STA Block Acknowledgement (M-STA BA) comprising a per Association Identifier Traffic Identifier Information (AID TID info) subfield that includes: a Block Acknowledgement (BA) starting sequence control that indicates that the per AID TID info subfield includes a low latency type of feedback; and the low latency indication for pending low latency data or low latency needs. Such embodiments further include sharing a TXOP with the STA based on the low latency indication using a trigger frame or contention-free end frame, a Multi-User Request to Send Transmission Status (MU-RTS TXS), or a Reverse Direction Grant (RDG). The low latency indication may be included in the per AID TID info subfield in place of a BA bitmap.

FIG. 9 is a flowchart illustrating a method 900 for an Access Point station (AP STA). The method includes: receiving 902, from a station (STA), a Stream Classification Service (SCS) request frame comprising a request to enable use of a low latency indication; and sending 904 an SCS response to the STA.

In certain embodiments of the method 900, the SCS request frame further comprises low latency indication parameters. The low latency indication parameters may include a suggested targeted Physical Protocol Data Unit (PPDU) length for non-low latency traffic. In certain embodiments, the request to enable use of the low latency indication and the low latency parameters are included in a quality of service (QoS) characteristic element of the SCS request frame. In certain such embodiments, the SCS request frame further comprises a minimum service interval and a maximum service interval, wherein when the minimum service interval and the maximum service interval are set to zero in uplink direction with the request to enable use of the low latency indication, an Access Point (AP) does not consider the QoS characteristic element as a reference for scheduling and only considers the QoS characteristic element for enabling the low latency indication.

In certain embodiments, when the AP STA is a transmission opportunity (TXOP) responder, the method 900 further includes generating, in response to pending low latency data or low latency needs, a Multi-Station Block Acknowledgement (M-STA BA) comprising a per Association Identifier Traffic Identifier Information (AID TID info) subfield that includes: a Block Acknowledgement (BA) starting sequence control that indicates that the per AID TID info subfield includes a low latency type of feedback; and the low latency indication for the pending low latency data or the low latency needs. In such embodiments, the method 900 further includes sending the M-STA BA to an associated STA or a TXOP holder to inform the associated STA or the TXOP holder of the pending low latency data or the low latency needs. The low latency indication may be included in the per AID TID info subfield in place of a BA bitmap. In certain embodiments, the method 900 further includes: receiving a trigger frame, a Multi-User Request to Send Transmission Status (MU-RTS TXS), or a Reverse Direction Grant (RDG) from the associated STA or the TXOP holder; and sending the pending low latency data or attending to the low latency needs in response to the trigger frame, the MU-RTS TXS, or the RDG.

In certain embodiments, when the AP STA is a transmission opportunity (TXOP) holder, the method 900 further includes receiving, from the STA, a Multi-STA Block Acknowledgement (M-STA BA) comprising a per Association Identifier Traffic Identifier Information (AID TID info) subfield that includes: a Block Acknowledgement (BA) starting sequence control that indicates that the per AID TID info subfield includes a low latency type of feedback; and the low latency indication for pending low latency data or low latency needs. Such embodiments further include sharing a TXOP with the STA based on the low latency indication using a trigger frame or contention-free end frame, a Multi-User Request to Send Transmission Status (MU-RTS TXS), or a Reverse Direction Grant (RDG). The low latency indication may be included in the per AID TID info subfield in place of a BA bitmap.

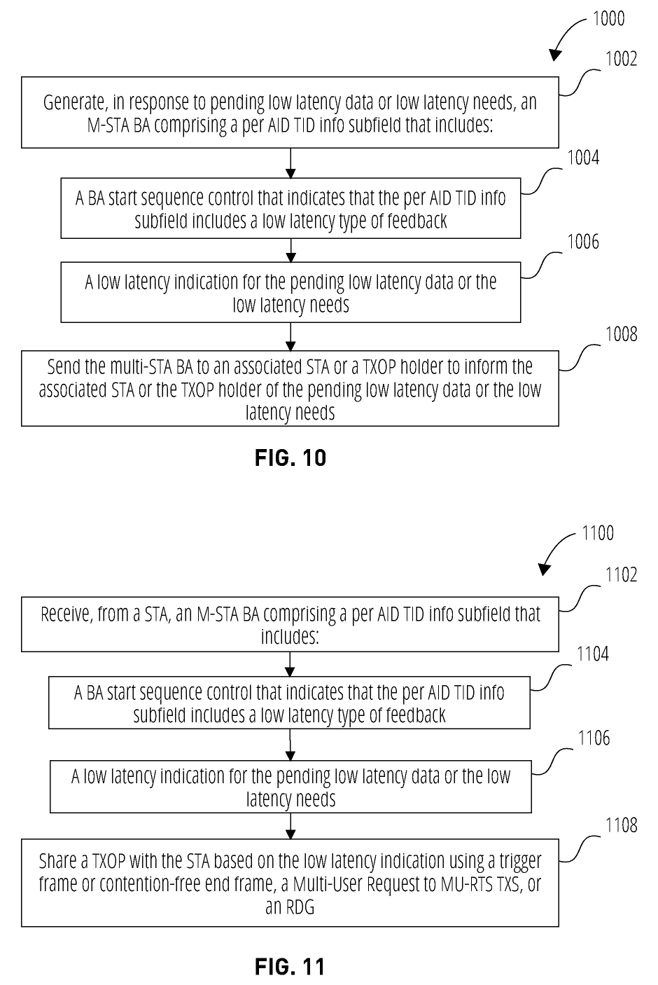

FIG. 10 is a flowchart illustrating a method 1000 for a transmission opportunity (TXOP) responder, in accordance with some embodiments. The method 1000 includes generating 1002, in response to pending low latency data or low latency needs, a Multi-Station (STA) Block Acknowledgement (M-STA BA) comprising a per Association Identifier Traffic Identifier Information (AID TID info) subfield that includes: a BA starting sequence control 1004 that indicates that the per AID TID subfield includes a low latency type of feedback; and a low latency indication 1006 for the pending low latency data or the low latency needs. The method 1000 further includes sending 1008 the multi-STA BA to an associated STA or a TXOP holder to inform the associated STA or the TXOP holder of the pending low latency data or the low latency needs.

In certain embodiments of the method 1000, the low latency indication is included in the per AID TID info subfield in place of a BA bitmap.

In certain embodiments, the method 1000 further includes: receiving a trigger frame, a Multi-User Request to Send Transmission Status (MU-RTS TXS), or a Reverse Direction Grant (RDG) from the associated STA or the TXOP holder; and sending the pending low latency data or attending to the low latency needs in response to the trigger frame, the MU-RTS TXS, or the RDG.

FIG. 11 is a flowchart illustrating a method 1100 for a TXOP holder, in accordance with some embodiments. The method 1100 includes receiving 1102, from a station (STA), a Multi-STA Block Acknowledgement (M-STA BA) comprising a per Association Identifier Traffic Identifier Information (AID TID info) subfield that includes: a BA starting sequence control 1104 that indicates that the per AID TID info subfield includes a low latency type of feedback; and a low latency indication 1106 for the pending low latency data or the low latency needs. The method 1100 further includes sharing 1108 a TXOP with the STA based on the low latency indication using a trigger frame or contention-free end frame, a Multi-User Request to Send Transmission Status (MU-RTS TXS), or a Reverse Direction Grant (RDG).

In certain embodiments of the method 1100, the low latency indication is included in the per AID TID info subfield in place of a BA bitmap.

For one or more embodiments, at least one of the components set forth in one or more of the preceding figures may be configured to perform one or more operations, techniques, processes, and/or methods as set forth herein. For example, a processor as described herein in connection with one or more of the preceding figures may be configured to operate in accordance with one or more of the examples set forth herein. For another example, circuitry associated with a STA or AP as described above in connection with one or more of the preceding figures may be configured to operate in accordance with one or more of the examples set forth herein.

Any of the above described embodiments may be combined with any other embodiment (or combination of embodiments), unless explicitly stated otherwise. The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

Embodiments and implementations of the systems and methods described herein may include various operations, which may be embodied in machine-executable instructions to be executed by a computer system. A computer system may include one or more general-purpose or special-purpose computers (or other electronic devices). The computer system may include hardware components that include specific logic for performing the operations or may include a combination of hardware, software, and/or firmware.

It should be recognized that the systems described herein include descriptions of specific embodiments. These embodiments can be combined into single systems, partially combined into other systems, split into multiple systems or divided or combined in other ways. In addition, it is contemplated that parameters, attributes, aspects, etc. of one embodiment can be used in another embodiment. The parameters, attributes, aspects, etc. are merely described in one or more embodiments for clarity, and it is recognized that the parameters, attributes, aspects, etc. can be combined with or substituted for parameters, attributes, aspects, etc. of another embodiment unless specifically disclaimed herein.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

Although the foregoing has been described in some detail for purposes of clarity, it will be apparent that certain changes and modifications may be made without departing from the principles thereof. It should be noted that there are many alternative ways of implementing both the processes and apparatuses described herein. Accordingly, the present embodiments are to be considered illustrative and not restrictive, and the description is not to be limited to the details given herein, but may be modified within the scope and equivalents of the appended claims.

1. A method for a non-Access Point station (non-AP STA), the method comprising:
generating a Stream Classification Service (SCS) request frame comprising a request to enable use of a low latency indication;
sending, to an Access Point (AP), the SCS request frame; and
receiving a SCS response from the AP.

2. The method of claim 1, wherein the SCS request frame further comprises low latency indication parameters.

3. The method of claim 2, wherein the low latency indication parameters comprise a suggested targeted Physical Protocol Data Unit (PPDU) length for non-low latency traffic.

4. The method of claim 2, wherein the request to enable use of the low latency indication and the low latency indication parameters are included in a quality of service (QoS) characteristic element of the SCS request frame.

5. The method of claim 4, wherein the SCS request frame further comprises a minimum service interval and a maximum service interval, and wherein the method further comprises:
when the minimum service interval and the maximum service interval are set to zero in uplink direction with the request to enable use of the low latency indication, indicating to the AP to not consider the QoS characteristic element as a reference for scheduling and only consider the QoS characteristic element for enabling the low latency indication.

6. The method of claim 1, when the non-AP STA is a transmission opportunity (TXOP) responder, the method further comprising:
generating, in response to pending low latency data or low latency needs, a Multi-Station Block Acknowledgement (M-STA BA) comprising a per Association Identifier Traffic Identifier Information (AID TID info) subfield that includes:
a Block Acknowledgement (BA) starting sequence control that indicates that the per AID TID info subfield includes a low latency type of feedback; and
the low latency indication for the pending low latency data or the low latency needs; and
sending the M-STA BA to an associated STA or a TXOP holder to inform the associated STA or the TXOP holder of the pending low latency data or the low latency needs.

7. The method of claim 6, wherein the low latency indication is included in the per AID TID info subfield in place of a BA bitmap.

8. The method of claim 6, further comprising:
receiving a trigger frame, a Multi-User Request to Send Transmission Status (MU-RTS TXS), or a Reverse Direction Grant (RDG) from the associated STA or the TXOP holder; and
sending the pending low latency data or attending to the low latency needs in response to the trigger frame, the MU-RTS TXS, or the RDG.

9. The method of claim 1, when the non-AP STA is a transmission opportunity (TXOP) holder, the method further comprising:
receiving, from a station (STA), a Multi-STA Block Acknowledgement (M-STA BA) comprising a per Association Identifier Traffic Identifier Information (AID TID info) subfield that includes
a Block Acknowledgement (BA) starting sequence control that indicates that the per AID TID info subfield includes a low latency type of feedback; and
the low latency indication for pending low latency data or low latency needs; and
sharing a TXOP with the STA based on the low latency indication using a trigger frame or contention-free end frame, a Multi-User Request to Send Transmission Status (MU-RTS TXS), or a Reverse Direction Grant (RDG).

10. The method of claim 9, wherein the low latency indication is included in the per AID TID info subfield in place of a BA bitmap.

11. A method for an Access Point station (AP STA), the method comprising:
receiving, from a station (STA), a Stream Classification Service (SCS) request frame comprising a request to enable use of a low latency indication; and
sending a SCS response to the STA.

12. The method of claim 11, wherein the SCS request frame further comprises low latency indication parameters.

13. The method of claim 12, wherein the low latency indication parameters comprise a suggested targeted Physical Protocol Data Unit (PPDU) length for non-low latency traffic.

14. The method of claim 12, wherein the request to enable use of the low latency indication and the low latency parameters are included in a quality of service (QoS) characteristic element of the SCS request frame.

15. The method of claim 14, wherein the SCS request frame further comprises a minimum service interval and a maximum service interval,
wherein when the minimum service interval and the maximum service interval are set to zero in uplink direction with the request to enable use of the low latency indication, an Access Point (AP) does not consider the QoS characteristic element as a reference for scheduling and only considers the QoS characteristic element for enabling the low latency indication.

16. The method of claim 11, when the AP STA is a transmission opportunity (TXOP) responder, the method further comprising:
generating, in response to pending low latency data or low latency needs, a Multi-Station Block Acknowledgement (M-STA BA) comprising a per Association Identifier Traffic Identifier Information (AID TID info) subfield that includes:
a Block Acknowledgement (BA) starting sequence control that indicates that the per AID TID info subfield includes a low latency type of feedback; and
the low latency indication for the pending low latency data or the low latency needs; and
sending the M-STA BA to an associated STA or a TXOP holder to inform the associated STA or the TXOP holder of the pending low latency data or the low latency needs.

17. The method of claim 16, wherein the low latency indication is included in the per AID TID info subfield in place of a BA bitmap.

18. The method of claim 16, further comprising:
receiving a trigger frame, a Multi-User Request to Send Transmission Status (MU-RTS TXS), or a Reverse Direction Grant (RDG) from the associated STA or the TXOP holder; and
sending the pending low latency data or attending to the low latency needs in response to the trigger frame, the MU-RTS TXS, or the RDG.

19. The method of claim 11, when the AP STA is a transmission opportunity (TXOP) holder, the method further comprising:
receiving, from the STA, a Multi-STA Block Acknowledgement (M-STA BA) comprising a per Association Identifier Traffic Identifier Information (AID TID info) subfield that includes:
a Block Acknowledgement (BA) starting sequence control that indicates that the per AID TID info subfield includes a low latency type of feedback; and
the low latency indication for pending low latency data or low latency needs; and
sharing a TXOP with the STA based on the low latency indication using a trigger frame or contention-free end frame, a Multi-User Request to Send Transmission Status (MU-RTS TXS), or a Reverse Direction Grant (RDG).

20. The method of claim 19, wherein the low latency indication is included in the per AID TID info subfield in place of a BA bitmap.
